(19) United States
(12) Patent Application Publication
(10) Pub. No.: US 2013/0305475 A1
(43) Pub. Date: Nov. 21, 2013

(54) WIPER CONNECTOR FOR VEHICLE

(71) Applicant: KCW Corporation, Daegu (KR)

(72) Inventors: Tae Kyeong Kim, Daegu (KR); Kwan Hee Kim, Kwan (KR); Jae Hyuck An, Daegu (KR)

(73) Assignee: KCW Corporation, Daegu (KR)

(21) Appl. No.: 13/673,552

(22) Filed: Nov. 9, 2012

(30) Foreign Application Priority Data
Nov. 9, 2011 (KR) 10-2011-0116273

(51) Int. Cl. B60S 1/40

(52) U.S. Cl. CPC B60S 1/40
USPC 15/250.32

(57) ABSTRACT

A wiper connector for a vehicle. The wiper connector includes: a body which is connected to the wiper arm by receiving a catching protrusion of the wiper arm through use of at least one coupling part formed on both sides thereof; and a cover part restricting forward and backward or upward and downward movement of the wiper arm coupled to the body, wherein the body includes a fitting part which is provided on the bottom surface thereof and is fitted and coupled to a fitting recess formed in a central portion of the wiper blade.

### CROSS-REFERENCE TO RELATED APPLICATIONS

This application claims the benefit of Korean Patent Application No. 10-2011-0116273, filed Nov. 9, 2011, the entirety of which is hereby incorporated by reference.

### FIELD OF THE INVENTION

The present invention relates to a wiper connector for a vehicle, which connects a wiper blade with a wiper arm.

### BACKGROUND OF THE INVENTION

In general, a wiper blade removes impurities, snow, rain or the like when driving and prevents a driver's front sight from being deteriorated and performs a repetitive reciprocating action in a fan shape as a motor drives a link apparatus connected to a wiper arm.

A conventional wiper blade includes a lever assembly configured by connecting levers of metal materials in a tournament type. In the lever assembly, a plurality of tournament levers curve a wiper strip, so that the wiper strip having a backing plate installed therein traces a curvature of a vehicle glass.

The wiper blade has a problem in that the wiper blade lifts by an air pressure applied to a glass surface when the vehicle is driven at a high speed and chattering occurs.

Further, in order to accept various types of wiper driving arms having different standards and shapes for each kind of vehicle, conventional wiper blades have been released in a dedicated product types corresponding to the wiper driving arms.

That is, the conventional driving arm for the vehicle is largely classified into a “U” shaped clip type having a catching structure, a bayonet type fitted as a plug type, a pin type forming a protrusion in a side portion and taking a fitting structure by the protrusion, a side hole type performing a fitting coupling in a side portion of a wiper apparatus, developed by a Bosch corporation, and a top-lock type performing a coupling by a covering structure in an upper portion of the wiper apparatus, and the various types of driving arms have a limitation in that they can use only dedicated wiper apparatuses since their shapes and sizes are different from each other.

### SUMMARY OF THE INVENTION

An aspect of the present invention is a wiper connector for a vehicle, which connects a wiper arm to a wiper blade. The wiper connector includes: a body which is connected to the wiper arm by receiving a catching protrusion of the wiper arm through use of at least one coupling part formed on both sides thereof; and a cover part restricting forward and backward or upward and downward movement of the wiper arm coupled to the body. The body includes a fitting part which is provided on the bottom surface thereof and is fitted and coupled to a fitting recess formed in a central portion of the wiper blade.

According to an embodiment of the present invention, at least one catching recess is formed in at least one side of the cover part. The body includes at least one elastic catching piece protruding outwardly in order to be coupled to the at least one catching recess.

According to an embodiment of the present invention, the body further includes a guide part for guiding a linear movement of the cover part.

According to an embodiment of the present invention, the body includes a coupling recess formed in both sides thereof. A pair of coupling protrusions formed within the cover part is coupled to the coupling recess, guides the forward and backward movements of the cover part and functions as a rotation axis when the cover part rotates.

According to an embodiment of the present invention, the body includes a pair of slit grooves on a bottom surface thereof.

According to an embodiment of the present invention, the wiper connector is selectively connected either to a wiper arm including a tap which contacts with the top surface and both sides of the wiper connector and extends toward the cover part, or to a wiper arm including a cap which contacts with the top surface and both sides of the wiper connector.

### BRIEF DESCRIPTION OF THE DRAWINGS

The embodiment will be described in detail with reference to the following drawings.

FIGS. 1a and 1b are a front view and a perspective view of a whole configuration of a wiper blade according to the present invention;

FIGS. 2a and 2b are a front view and a perspective view of a whole configuration of the wiper blade in which an adaptor part is formed according to the present invention;

FIG. 3a is a perspective view of one end of a wiper strip according to the present invention;

FIG. 3b is a perspective view of the other end of the wiper strip according to the present invention;

FIG. 4 is a front exploded view showing a cover and a lever assembly of the wiper blade according to the present invention;

FIG. 5 is a perspective view of the cover and the lever assembly of the wiper blade separated from each other according to the present invention;

FIG. 6 is a perspective plan view of the cover and the lever assembly of the wiper blade according to the present invention;

FIG. 7a is an axial directional cross-sectional view with respect to VC in FIG. 6;

FIG. 7b is an axial directional cross-sectional view with respect to VB in FIG. 6;

FIG. 7c is an axial directional cross-sectional view with respect to VA in FIG. 6;

FIG. 7d is an axial directional cross-sectional view with respect to IVC in FIG. 6;

FIG. 7e is an axial directional cross-sectional view with respect to IVB in FIG. 6;

FIG. 7f is an axial directional cross-sectional view with respect to IVA in FIG. 6;

FIG. 8a is a top view of a connection holder part of the wiper blade according to the present invention;

FIG. 8b is a front view of the connection holder part of the wiper blade according to the present invention;

FIG. 8c is an exploded perspective view of the connection holder part of the wiper blade according to the present invention;

FIGS. 9a and 9b are perspective views of the wiper blade equipped with a wiper arm according to the present invention;

FIG. 10a is a perspective view of an adaptor part of the wiper blade according to a first embodiment of the present invention;

FIG. 10b is a transverse cross-sectional view of the adaptor part of the wiper blade shown in FIG. 10a;

FIG. 11a is a perspective view of an adaptor part of the wiper blade according to a second embodiment of the present invention;

FIG. 11b is a transverse cross-sectional view of the adaptor part of the wiper blade shown in FIG. 11a;

FIGS. 12a and 12b are perspective views of an adaptor part of the wiper blade according to a third embodiment of the present invention;

FIGS. 13a and 13b are perspective views of an adaptor part of the wiper blade according to a fourth embodiment of the present invention;

FIG. 13c is a bottom perspective view of the adaptor part of the wiper blade according to the fourth embodiment of the present invention;

FIG. 14a is a perspective view of the connector according to the first embodiment of the present invention;

FIG. 14b is a perspective view of a rotated head part of the connector according to the first embodiment of the present invention;

FIG. 14c is a perspective view showing a state where a connector body and a cover part of the connector according to the first embodiment of the present invention are separated from each other;

FIG. 14d is a rear view of the connector according to the first embodiment of the present invention;

FIGS. 15a and 15b are perspective views showing that the wiper arm is coupled to the connector according to the first embodiment of the present invention;

FIG. 16a is a perspective view of the connector according to a second embodiment of the present invention;

FIG. 16b is a plan view of the connector according to the second embodiment of the present invention as viewed from the top;

FIG. 16c is a rear view of the connector according to the second embodiment of the present invention;

FIG. 16d is a bottom perspective view of the connector according to the second embodiment of the present invention;

FIG. 17a is a perspective view showing the wipe blade assembly coupled to the connector according to the first embodiment of the present invention;

FIG. 17b is a perspective view of FIG. 17a without the cover part;

FIG. 18a is a perspective view showing the wipe blade assembly coupled to the connector according to the second embodiment of the present invention;

FIG. 18b is a perspective view of FIG. 18a without the cover part.

### DETAILED DESCRIPTION OF THE INVENTION

The following detailed description of the present invention shows a specified embodiment of the present invention and will be provided with reference to the accompanying drawings. The embodiment will be described in enough detail that those skilled in the art are able to embody the present invention. It should be understood that various embodiments of the present invention are different from each other and need not be mutually exclusive. For example, a specific shape, structure and properties, which are described in this disclosure, may be implemented in other embodiments without departing from the spirit and scope of the present invention with respect to one embodiment. Also, it should be noted that positions or placements of individual components within each disclosed embodiment may be changed without departing from the spirit and scope of the present invention. Therefore, the following detailed description is not intended to be limited. If adequately described, the scope of the present invention is limited only by the appended claims of the present invention as well as all equivalents thereto. Similar reference numerals in the drawings designate the same or similar functions in many aspects.

Hereinafter, the present invention will be described with reference to the accompanying drawings. A detailed description of the components of the present invention which can be clearly grasped and easily implemented by those skilled in the art through the prior arts will omitted not to make the subject matter of the present invention unclear.

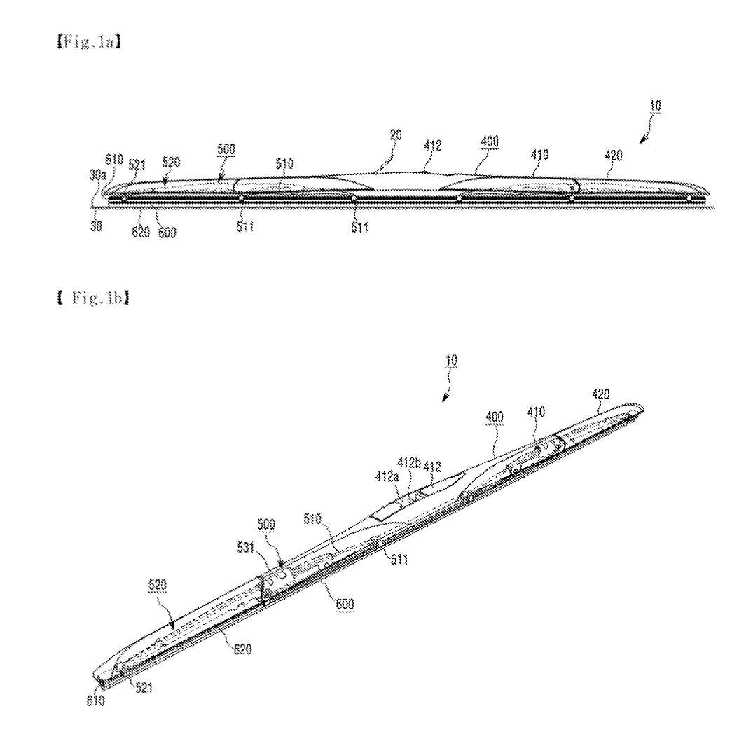

FIGS. 1a and 1b are front view and a perspective view showing an embodiment including some characteristics of a wiper blade according to the present invention.

Referring to FIGS. 1a and 1b, a wiper blade 10 according to the present invention includes an adaptor part 200 (not shown in FIGS. 1a and 1b) connected with a connector 300 (not shown) provided at an upper end of the wiper blade 10 and configured to fixedly support an end portion of a wiper arm 20, a wiper strip 600 coming into contact with a window glass surface of a vehicle to wipe the window glass surface of the vehicle, a plurality of lever assemblies 500 connected to each other in a tournament type and configured to support the wiper strip 600, and a cover 400 for receiving the lever assemblies 500.

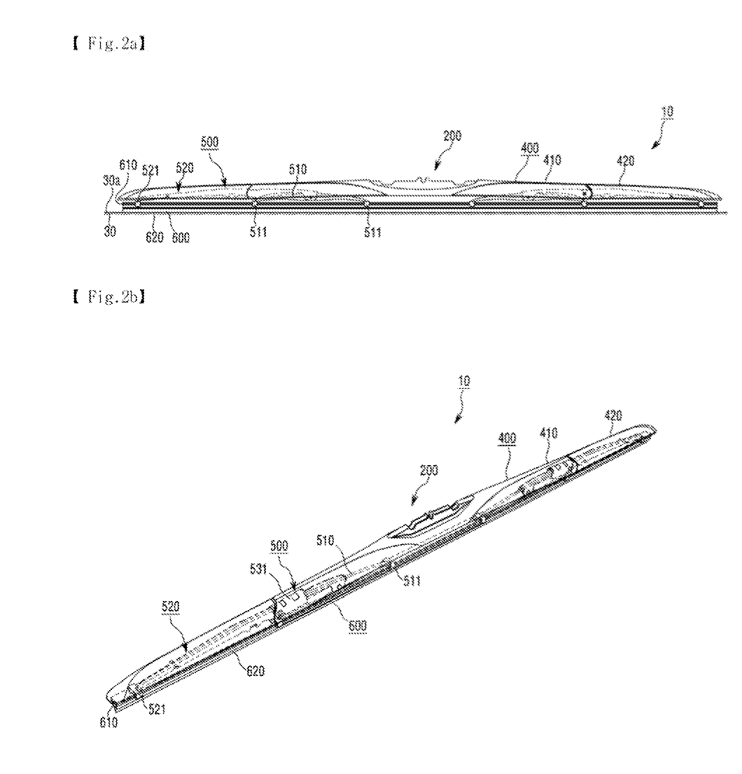

FIGS. 2a and 2b are a front view and a perspective view of the wiper blade according to another embodiment of the present invention.

Referring to FIGS. 2a and 2b, the adaptor part 200 is provided at the vicinity of a center of the cover 400 of the wiper blade of FIGS. 1a and 1b. The connector 300 is mounted to the adaptor part 200, which will be described below in detail, and the connector 300 receives a front end of the wiper arm 20.

Hereinafter, the wiper blade shown in FIGS. 1a and 1b will be described in detail.

The wiper blade 10 is connected to the front end of the wiper arm (not shown), and receives a pressurizing force from the wiper arm with respect to a glass surface 30a (a wiping surface) of vehicle glass 30. The wiper arm is reciprocately rotated at a predetermined angle by a wiper motor (not shown), and the wiper blade 10 wipes on the glass surface 30a within a range of the predetermined angle.

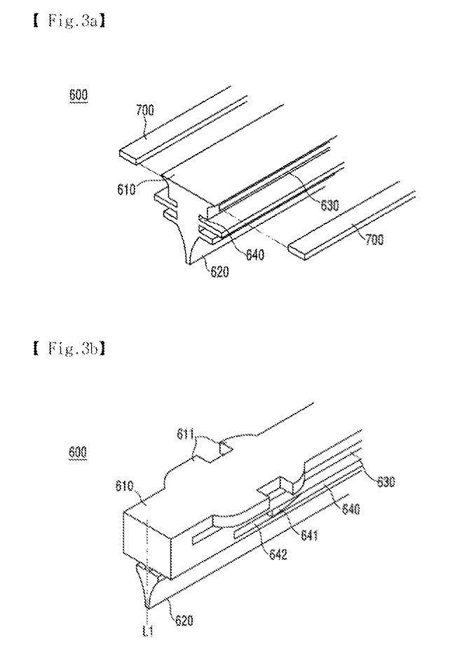

FIGS. 3a and 3b are partial perspective views showing respectively one end and the other end of the wiper strip 600.

As shown in FIGS. 1a, 1b, 3a, and 3b, the wiper blade 10 further includes two backing plates 700 mounted to the wiper strip 600. The lever assembly 500 includes a plurality of first levers 510 and a plurality of second levers 520. For convenience of description of the present invention, the wiper blade 10 comprised of a pair of the first levers 510 and a pair of the second levers 520 will be described.

Referring to FIGS. 1a, 1b, 3a and 3b, the wiper strip 600 includes a wiping lip part 620 directly coming into contact with the glass surface 30a to perform the wiping action, and a base part 610 supported by the lever assembly 500. The wiper strip 600 is disposed to slidably come into contact with the glass of the vehicle and removes a foreign material from a surface of the glass. The wiper strip 600 extends in a longitudinal direction and is made of an elastic material such as a rubber material or an elastic synthetic material.

The base part 610 is supported by fasteners 511 and 521 of a first lever 510 and a second lever 520 of the lever assembly 500. The fasteners 511 and 521 may have a yoke shape. The base part 610 and the wiping lip part 620 continuously extend in a longitudinal direction of the wiper strip 600. A receiving groove 630 for receiving the two backing plates parallel to each other in the longitudinal direction extends on the base part 610. The two backing plates 700 corresponding to rectangular metal material plates having spring properties are received in two backing plate receiving grooves 630, respectively. A holding part 640 is a part for receiving the fasteners 511 and 521 in a sliding type.

The holding part 640 at one end of the wiper strip 600 shown in FIG. 3a is an open type capable of receiving the fasteners 511 and 521, but the other end shown in FIG. 3b is formed to restrict a longitudinal direction movement of the second fastener 521 of the second lever. That is, one of the second fasteners 521 of the second lever 520 is restricted by a wall of a slope 641 and a coupling part 642 provided only at the other end of the holding part 640. Further, the longitudinal direction movement of the second fastener 521 is restricted by a protrusion part 611.

The backing plate 700 applies elasticity and stiffness to the wiper lip part 620. When a pressurizing force is applied from the wiper arm, the pressurizing force is distributed to the wiper strip 600 through the lever assembly 500. At this time, the pressurizing force spreads in the longitudinal direction of the wiper strip 600 by the backing plate 700. Accordingly, the backing plate 700 should have elasticity and stiffness to maintain a shape of the wiper strip 600. The number of backing plates 700 and backing plate receiving grooves 630 may be two or more according to a degree of stiffness or elasticity of the wiper strip.

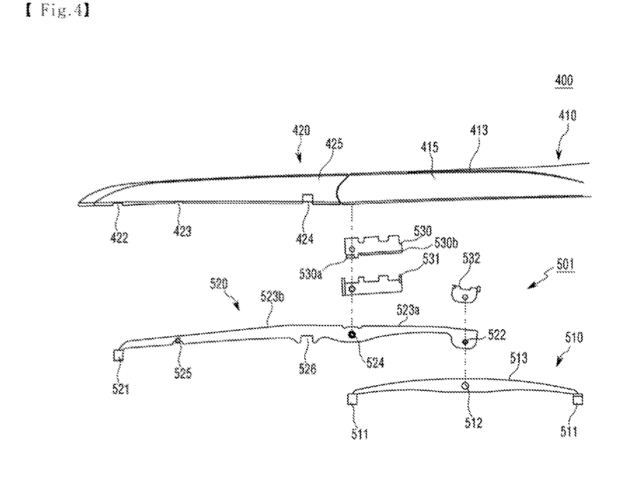

FIG. 4 is a front exploded view showing a cover and a lever assembly of the wiper blade according to the present invention.

FIG. 5 is a perspective view of the cover and the lever assembly of the wiper blade separated from each other according to the present invention.

Referring to FIGS. 1a, 1b, 4 and 5, according to an embodiment of the present invention, the lever assembly 500 includes a pair of first levers 510 and a pair of second levers 520 hinge-coupled to the first levers 510 and coupled to the cover 400.

The first lever 510 is coupled to a wiper center directional front end of the second lever 520, and hinge-coupled to rotate about a coupling axis of the first lever 510.

According to the embodiment of the present invention, the first lever 510 may be provided at a position spaced apart from a center of the wiper blade 10 by a predetermined distance. One end of the second lever 520 is hinge-coupled to the first lever 510 and a central portion of the second lever 520 is coupled to the cover 400. The other end of the second lever 520 supports the wiper strip 600. For example, it is possible to obtain a six-point support structure in which a pair of the first levers 510 supports four points and a pair of the second levers 520 supports two points. That is, each of the pair of the first levers 510 supports two points of the wiper strip 600. Each of the pair of the second levers 520 supports one point of the wiper strip 600. By doing this, the lever assembly 500 including a pair of the first levers 510 and a pair of the second levers 520 are able to as a whole support six points of the wiper strip 600.

When the wiper strip 600 is supported by the six-point support structure, the second lever 520 is able to sufficiently pressurize the end of the wiper strip.

In general, the longitudinal central portion of the backing plate 70 inserted into the wiper strip 600 is concavely curved separately from the glass surface 60a. For instance, when the lever assembly 500 is not able to pressurize both ends of the wiper strip 600, a pressurizing force given to the lever assembly 500 may not be distributed to the entire wiper strip 600. Therefore, for the purpose of stable wiping, the curvature of the backing plate 700 should be larger than that of the glass surface 30a. In other words, the curvature radius of the backing plate 700 should be smaller than that of the glass surface 30a.

However, according to the embodiment of the present invention, the six-point support structure of the lever assembly 500 is able to distribute, in a longitudinal direction of the wiper strip 600, the pressurizing force given to the lever assembly 500. Therefore, the curvature of the backing plate 700 may be smaller than that of the glass surface 30a or the backing plate 700 may have no curvature. It spends a lot of processing time to correctly adjust the curvature of the backing plate 700 in accordance with the pressurizing force applied to the wiper blade 10. The six-point support structure of the lever assembly 500 according to the embodiment of the present invention is able to stably distribute a load to the wiper strip 600 by using the backing plate 700 having a small curvature or no curvature.

Referring to FIGS. 1a and 1b to 5, the first lever 510 supports the base part 610 of the wiper strip 600. According to the embodiment of the present invention, the first lever 510 slidably supports the base part 610 of the wiper strip 600.

Referring to FIGS. 1a, 1b, 3a and 3b, the backing plate 700 may have a curvature in order to fit the curvature of the glass surface 30a. According to the embodiment, when the curvature of the wiper blade 10 is maintained by the first lever 510 and the second lever 520, the backing plate 700 may have no curvature. The lever assembly 500 and the cover 400 distribute the pressurizing force applied from the wiper arm to the wiper strip 600.

Each of the pair of the first levers 510 includes two first fasteners 511, two first through holes 512 and two arm parts 513.

The first lever 510 is formed to have a mountain fold extending in a longitudinal direction by press-processing a metal plate. The first lever 510 is formed to have an arch shape of which a center is convex toward the cover 400. The first lever 510 is formed to have a U-shaped cross section which is opened to the lower portion thereof.

The first through hole 512 of the first lever 510 may be formed in the center of the first lever 510 for a hinge coupling to the second lever 520. The first through hole 512 is opened in a width direction of the first lever. The first through hole 512 is coupled to a second through hole 522 of the second lever 520 described below. The first through hole 512 and the second through hole 522 are more securely coupled to each other by inserting and fitting a second spacer 532 between the first through hole 512 and the second through hole 522. The first fastener 511 for supporting the wiper strip 600 is formed in both ends of the first lever 510. The first fastener 511 slidably supports the wiper strip 600.

As a result, the lever assembly 500 according to the embodiment of the present invention is comprised of two symmetrical portions including the one first lever 510 and the one second lever 520. The second levers 520 are connected to each other through the cover 400. That is, the cover 400 formed of a resin material functions as a lever which may be commonly formed of a metallic material, so that the weight of the entire wiper blade 10 may be reduced. When the cover 400 is formed of a resin material instead of a metallic material, the cover 400 can be integrally formed, so that the number of parts can be reduced. Therefore, processes can be simplified and manufacturing costs can be reduced. Moreover, since the cover 400 is formed of a resin material, the flexibility of the external appearance of the wiper blade 10 may be increased. With the increase of the flexibility of shape of the cover 400, it is easier to transform the cover 400 in order to prevent damages caused by traveling wind.

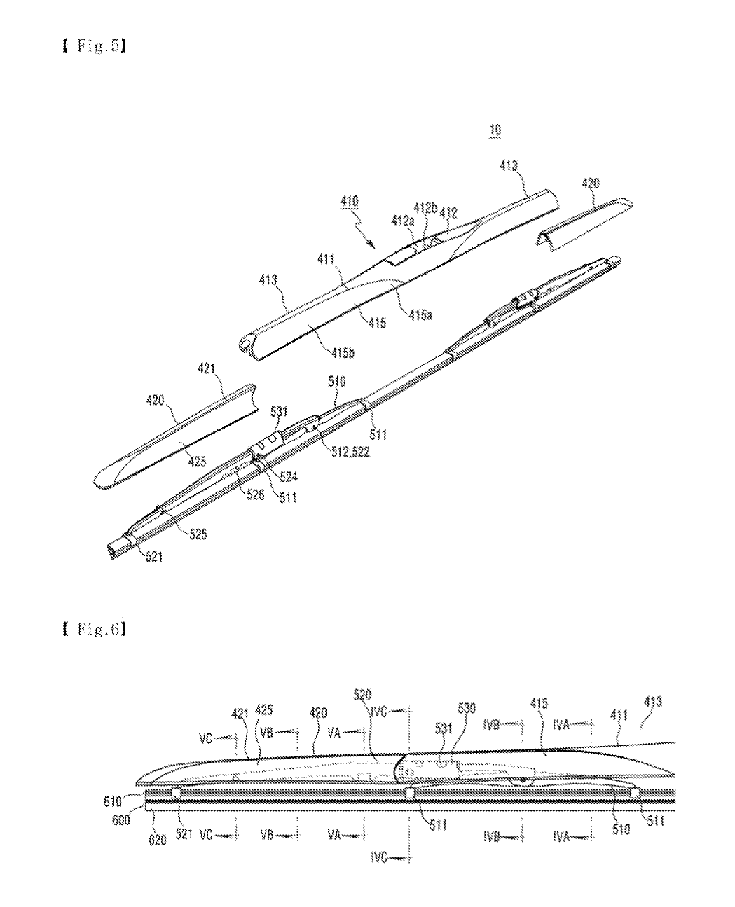

FIG. 6 is a front perspective plan view showing that the cover 400 and the lever assembly 500 of the wiper blade 10 have been coupled to the wiper strip 600 of the wiper blade 10.

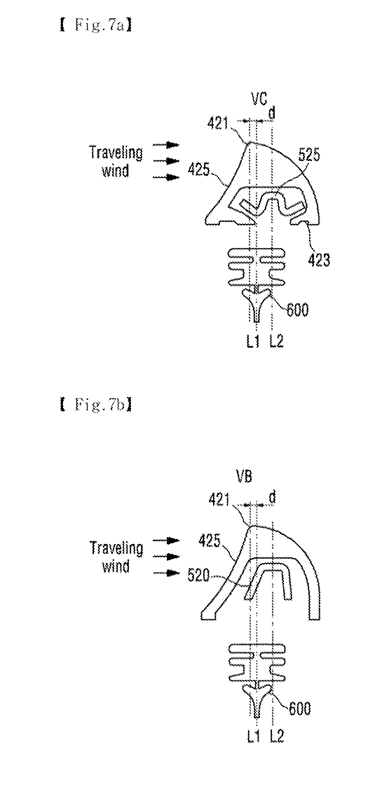

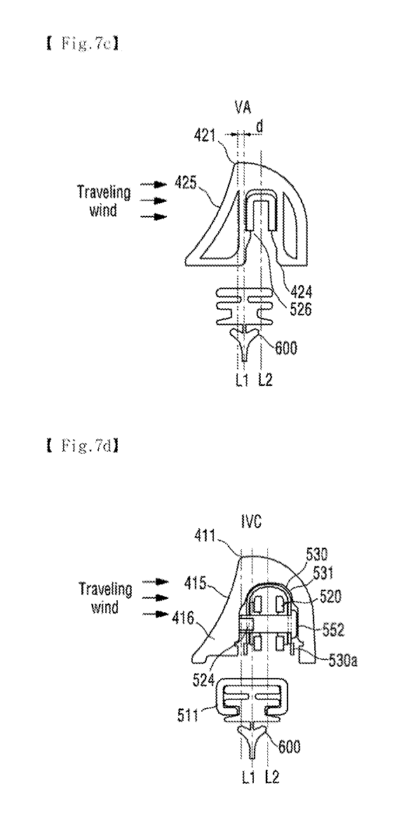

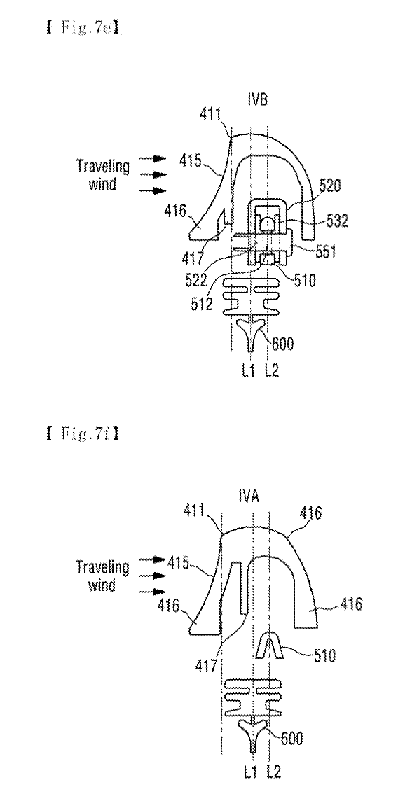

FIGS. 7a to 7f are axial directional cross-sectional views with respect to VC to IVA in FIG. 6.

Referring to FIGS. 7a to 7f, a transverse centerline of the first lever 510 is L2. The center of the transverse length of the upper portion of the second lever 520 corresponds to L2. Hereafter, L2 is referred to as a transverse centerline of the lever assembly 500. The transverse centerline L2 of the lever assembly 500 is offset from a transverse centerline L1 of the wiper strip 600. The first fastener 511 of the first lever 510 may have a yoke shape.

As the axial directional cross-section with respect to IVC of FIG. 6 is shown in FIG. 7d, the transverse centerline of the first fastener 511 corresponds to the transverse centerline L1 of the wiper strip 600.

As shown in FIGS. 4 and 5, the second lever 520 transfers the pressurizing force caused by the wiper arm 20 to the first lever 510. Further, the second lever 520 supports the wiper strip 600. The second lever 520 is coupled to the cover 400 to maintain a whole shape of the wiper blade 10.

Each of a pair of the second levers 520 includes the second fastener 521 for supporting the wiper strip 600, the second through hole 522 for a hinge coupling to the first lever 510, two arm parts 523a and 523b, a third through hole 524 for a coupling to a central cover (fixing cover) 410, a first connection groove 525 and a second connection groove 526 for a coupling to a side cover (moving cover) 420 of the cover 400.

The second lever 520 is formed in an arch shape toward the cover 400. The second lever 520 is formed to have a U-shaped cross section which is opened to the lower portion thereof. Accordingly, the central directional arm part 523a of the second lever 520 may receive a portion of the first lever 510. Since the lower portion of the cross section of the second lever 520 and the cross section of the first lever 510 have all U-shape, it is possible to reduce a gap between the first lever 510 and the second lever 520 when a portion of the first lever 510 is received in the second lever 520. As a result, a wiping performance can be maintained satisfactory by causing the wide blade 10 to contact more closely with the glass surface.

The arm part 523 includes the wiper central directional arm part 523a and the front end directional arm part 523b. The wiper central directional arm part 523a of the second lever 520 has the second through hole 522 formed therein and is hinge coupled to the first lever 510. The second through hole 522 may be formed in one end of the second lever 520.

As shown in FIG. 7e, a first connecting pin 551 passes through the first through hole 512 and the second through hole 522 and then couples the first lever 510 to the second lever 520. Also, as shown in FIG. 7d, a second connecting pin 552 passes through the third through hole 524 and then couples the second lever 520 to the cover 400.

The first connection groove 525 and the second connection groove 526 for the coupling to the cover 400, and the second fastener 521 for supporting the wiper strip are formed in the front end directional arm part 523b of the second lever 520. Though not shown, similarly to the first fastener 511 of the first lever 510, a transverse centerline of the second fastener 521 corresponds to the transverse centerline L1 of the wiper strip 600. The second fastener 521 may have a yoke shape. Further, the third through hole 524 for the hinge coupling to the cover 400 is formed in the second lever 520.

As shown in FIG. 4, the second lever 520 may further include a first spacer 531 and a spacer clip 530 in order to be coupled to the cover 400. A rib 530b is formed at the outside of the lower portion of the spacer clip 530 in the longitudinal direction of the central cover 410. Regarding the spacer clip 530, the rib 530b may be coupled to a slot 413a of the central cover 410 in a sliding manner. When the rib 530b is coupled to a slot 413a of the central cover 410, an elastic latch 530a is caught by the end portion of the slot 413a so that the backward movement of the spacer clip 530 is restrained and the coupling is strengthened.

As shown in FIGS. 4, 5 and 7d, the first spacer 531 is provided at a position where the third through hole 524 of the second lever 520 is located and the spacer clip 530 is provided between the first spacer 531 and the central cover 410. The first spacer 531 not only strengthens the hinge-coupling structure between the second lever 520 and the cover 400, but causes the wiper strip 600 to more closely contact with the glass surface 30a by more pressurizing the second lever 520.

The spacer clip 530 has an arch-shaped transverse cross section and is rectangularly formed to surround the first spacer 531 in the longitudinal direction thereof. A rib 530b is formed at the outside of the lower portion of the spacer clip 530 in the longitudinal direction of the central cover 410.

Regarding the spacer clip 530, the rib 530b may be coupled to the slot of the central cover 410 in a sliding manner. The spacer clip 530 allows the central cover 410 to be stably coupled to the second lever 520. The first spacer 531 and the spacer clip 530 integrally move, and as a result, the second lever 520 is able to easily pivot. The first spacer 531 made of a resin material is capable of preventing abrasion caused by friction between the spacer clip 530 and the second lever 520 made of a metallic material, and of causing the spacer clip 530 to more pressurize the second lever 520.

The second spacer 532 is inserted into a portion where the first lever 510 and the second lever 520 are hinge-coupled, thereby strengthening the coupling of the second lever 520 and the first lever 510.

As shown in FIGS. 4 and 5, the third through hole 524 and the first fastener 511 located at the front end of the first lever 510 may be formed separately from the front end of the wiper blade 10 by the same distance. That is, a pivot axis of the second lever 520 is on the same line with the first fastener 511 located at the front end of the first lever 510. If the third through hole 524 is closer to the front end than the first fastener 511, an excessive load is distributed to the second fastener 521 and a relatively less load is distributed to the first fastener 511. Accordingly, the first fastener 511 is not able to give a predetermined pressure to the glass surface, so that a wiping performance of the first fastener 511 is degraded. On the contrary, if the first fastener 511 is closer to the front end than the third through hole 524, a load is not sufficiently transferred to the second fastener 521, so that a wiping performance of the second fastener 521 is degraded. However, there is no limit to this. A longitudinal length of the first lever 510, i.e., a distance between the first fasteners 511 can be controlled according to the curvature of the glass surface of a vehicle.

Here, a plurality of the first fasteners 511 of the first lever 510 and the fastener 521 of the second lever may support the wiper strip 600 at an equal interval. In this case, a pressurizing force applied to the fastener 521 of the second lever 520 is greater than a pressurizing force applied to the fastener 511 of the first lever 510. Therefore, in the wiping of the wiper strip 600, efficient wiping is obtained by preventing the lifting and chattering of the wiper.

Referring to FIG. 6, the cover 400 receives the lever assembly 500 and distributes the pressurizing force from the wiper arm to the lever assembly 500, thereby causing the wiper strip 600 to more closely contact with the glass surface 30a.

As shown in FIGS. 4, 5, and 6, the cover 400 includes the central cover 410 and the two side covers 420. The covers 410 and 420 include finned sections 415 and 425 according to the present invention. Upper front ends of the finned sections 415 and 425 of the cover 400 are comprised of an upper front end 411 of the central finned section 415 formed in the central cover 410 and an upper front end 421 of the side finned section 425 formed in the side cover 420.

The side covers 420 are located in both ends of the central cover 410, respectively. The central cover 410 and the side cover 420 are made of a resin material respectively and have a predetermined rigidity.

Further, the central cover 410 and the side cover 420 are coupled to each other to configure the cover 400, and the cover 400 extends in a longitudinal direction of the wiper blade 10. A length of the longitudinal direction of the cover 400 is greater than a length of a longitudinal direction of the lever assembly 500. The cover 400 together with the wiper strip 600 forms an integrally external appearance.

Referring to FIGS. 7a to 7e, the entire cross section of the second lever 520 including the first connection groove 525, the front end directional arm part 523b and the second connection groove 526 has a lower space having a trapezoidal shape. Therefore, when the wiper blade 10 wipes the glass surface of a vehicle, durability of the wiper blade 10 is enhanced with respect to a torsional moment transferred to the wiper blade 10 in accordance with the change of the wiping direction.

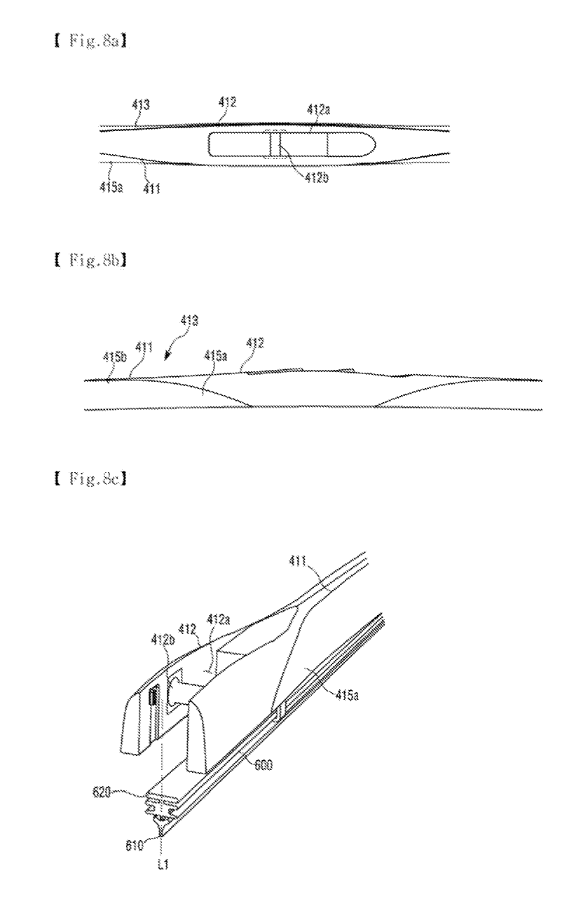

FIG. 8a is a top view of a connection holder part of the wiper blade according to the present invention.

FIG. 8b is a front view of the connection holder part of the wiper blade according to the present invention.

FIG. 8c is an exploded perspective view of the connection holder part of the wiper blade according to the present invention.

Referring to FIGS. 1a, 1b, 2a 2b 4, 5, 8a, 8b and 8c the central cover 410 includes a connection holder part 412 for a connection with the wiper arm 20, a pair of first lever covers 413 and a pair of the central finned sections 415. Each of the pair of the central finned sections 415 has the central finned section upper front end 411 formed therein.

As shown in FIG. 5, the connection holder part 412 is located approximately in a center of the central cover 410, a lower portion of the connection holder part 412 does not receive the lever assembly 500, and an opening 412a for a coupling to the wiper arm 20 or the adaptor part 200 as shown in FIGS. 2a and 2b may be formed in the connection holder part 412.

The lever cover 413 is disposed in both ends of the connection holder part 412 so as to cover the entire first lever 510.

The central cover 410 is formed to have the arch shape convex toward the wiper arm, thereby causing the wiper strip 600 to indirectly contact more closely with the glass surface of a vehicle by applying an external force to the lever assembly 500.

As shown in FIGS. 5, 8a, 8b, and 8c, the connection holder part 412 does not receive the lever made of a metallic material therein, so that a degree of freedom of a shape is increased. That is, it is easy to form the finned section in the connection holder part 412. In other words, the external shape of the connection holder part 412 may include a connection holder part finned section 415a in such a manner as to efficiently distribute a pressurizing force to the entire wiper blade 10 in accordance with traveling wind when the vehicle is driven. The connection holder part finned section 415a distributes air flows to the front end of the cover 400 to prevent the wiper blade 10 from lifting.

Referring FIGS. 7d, 7e, and 7f, a thickened portion 416 is installed in each internal vertex of the cross section of the central cover 410. Accordingly, the central cover 410 increases resistance to a torsional moment and rigidity. A rib 417 is provided at an interior of the central cover 410 in order to prevent a gap between internal structures.

The rib 417 is formed within the central cover 410 and reduces a gap between the central cover 410 and the first lever 510 received in the central cover 410. As a result, the lateral movement of the first lever 510 is limited and thus the wiping is stably performed.

Referring to FIGS. 8a and 8c, the connection holder part 412 is formed to have parallel walls, and the transverse center of the connection holder part 412 corresponds to the transverse centerline L1 of the wiper strip 600. A vehicle front exterior of the connection holder part 412 may include the connection holder part finned section 415a in a lower portion thereof. An upper front end of the connection holder part finned section 415a forms a portion of a curve which starts from the lower portion of the connection holder part 412 and meets the central finned section upper front end 411, i.e., the upper front end of the cover 400 with the approach to both ends of the wiper blade 10. Accordingly, the central finned section 415 formed in the central cover 410 forms a finned section formed integrally with the first lever cover 413 and the connection holder part 412, and makes it easier to transfer a pressurizing force caused by traveling force to the entire cover 400.

The adaptor part (not shown), which can be coupled to the connector (not shown), may be provided within the connection holder part 412 in a front side of the vehicle. The edge of the opening 412a of the connection holder part 412 may have a curvature and transfers stress concentrated on the opening 412a of the connection holder part 412 to the first lever cover 413 of the central cover 410.

Referring to FIG. 8a, the connection holder part 412 is rotatably connected to the front end of the wiper arm through a connection clip 412b.

The connection clip 412b is a component used to connect the connection holder part 412 with the connector (not shown). The connection clip 412b of the present invention is made of a flexible material which is tougher than a conventional material. Since the connection clip 412b is made of a tougher material, the connection clip 412b can be prevented from being damaged by friction between the wiper arm and the connection clip 412b. When the wiping is performed, the most torsional moment and stress caused by torsion are applied to the connection clip 412b. Therefore, the tough and flexible material is used as a material of the connection clip 412b, thereby improving resistance to the torsional moment and stress which are applied to the connection holder part. The connection clip 412b is more flexible than the cover 400. Therefore, even though the connection clip 412b is inserted into the inside of the connection holder part 412, the connection holder part 412 is not projected. Accordingly, the external appearance is not affected, and thus integrality of the shapes of the finned sections 415 and 425 can be maintained. As a result, the connection clip 412b is able to function to reinforce the rigidity of the cover 400 when the cover 400 is made of a resin material.

Referring to FIGS. 4, 5, 7e, 7f, 8a, 8b and 8c, the first lever covers 413 are located in both ends of the central cover 410 and extend in the longitudinal direction of the wiper blade 10. The first lever cover 413 has an opening in the lower portion thereof, and the opening is formed to have a U-shape to receive the first lever 150. The central directional arm part 523a of the second lever 520 receives a portion of the first lever 510. The first lever cover 413 receives the central directional arm part 523a of the second lever 520. The central finned section 415 of the central cover 410 includes the connection holder part finned section 415a formed in the connection holder part and a first lever cover finned section 415b formed in the first lever cover 413. The connection holder part finned section 415a and the first lever cover finned section 415b integrally form the central finned section 415. The connection holder part finned section 415a is formed in the connection holder part 412 of the wiper blade 10 and distributes traveling wind from a front side of the vehicle from side to side. The connection holder part finned section 415a extends from the lower portion of the connection holder part 412 to both front ends of the wiper blade 10. The first lever cover finned section 415b is formed in the first lever cover 413 and causes the traveling wind to flow from side to side or upward.

The first lever cover 413 is integrally formed with the central finned section 415. The central finned section 415 generating a pressurizing force pressurizing the wiper strip 600 against the glass surface 30a by receiving the traveling wind applied to a vehicle being driven is formed to be inclined.

Referring to FIGS. 4, 5, 6, 7a, 7b and 7c, the side cover 420 receives at least a portion of the second lever 520. The side cover 420 has an opening in a lower portion thereof. The opening is formed to have a U-shape to receive the second lever 520. As shown in FIGS. 7a, 7b and 7c, an upper front end 421 of the side finned section 425 is offset at a predetermined distance to a transverse one side of the transverse centerline L1 from the transverse centerline L1 of the wiper strip 600.

The side cover 420 includes the side finned section 425 extending from the finned section 415b of the first lever cover 413. The side cover 420 receives the front end directional arm part 523b of the second lever 520.

The side finned section 425 is formed concave toward the wiper strip 600 from the side finned section upper front end 421 offset from the transverse centerline of the wiper blade 10. The inner lower portion of the side cover 420 should have a space for receiving the second lever 520. Therefore, the inner lower portion of the side cover 420 should have should have a predetermined depth in such a manner as to receive the second lever 520. When the side finned section upper front end 421 is formed on the rear side of the vehicle, the depth of the receiving space formed in the inner lower portion of the side cover 420 becomes smaller, and thus the second lever 520 cannot be completely received. In the embodiment of the present invention, the side finned section upper front end 421 is offset from the transverse centerline L1 of the wiper strip 600 in a front direction of the vehicle such that the second lever 520 is completely received and prevented from being shaken, so that the wiping can be stably performed.

Also, as shown in FIGS. 7a to 7c, the offset “d” of the side finned section 425 is maintained constant along the front end of the side cover 420. Accordingly, the traveling wind flows in a top direction of the wiper blade 10. As a result, the lifting and chattering of the wiper blade 10 are prevented.

That is, when a vehicle is driven, the traveling wind flows from the central portion of the wiper blade 10 to the right and left and upper side of the cover 400 along the finned sections 415 and 425. As a result, the upper front ends 411 and 421 of the finned sections 415 and 425 are offset from transverse centerline L1 of the wiper blade 10 to the front side of the vehicle, so that even though the transverse lengths of the finned sections 415 and 425 are relatively small, the wiper blade 10 maintains an excellent wiping performance.

Referring to FIG. 4, the side cover 420 includes a support protrusion 422 supporting the second lever 520. An upper portion of the second fastener 521 of the second lever 520 is supported by the support protrusion 422 of the side cover 420. The support protrusion 422 prevents transformation due to a moment of the second lever 520 by preventing the second fastener 521 of the second lever 520 from rotating in a direction of the side cover 420. Further, the side cover 420 includes a first coupling protrusion 423 and a second coupling protrusion 424 which integrally couple the second lever 520 with the side cover 420 and prevent the second lever 520 from being separated from the side cover 420.

Referring to FIGS. 4, 5, 7a, 7b and 7c, the side finned section 425 is integrally formed with an upper portion surface of the side cover 420. More specifically, the finned section 425 is implemented by a shape change of the upper portion surface of the side cover 420. The finned section 425 functions to induce an air flow such that air moving to a glass side of the vehicle pressurizes the side cover 420 in a direction closer to the vehicle glass 30 when the wiping is performed.

Referring to FIGS. 7a to 7c, the first coupling protrusion 423 may be formed to protrude inwardly from a bottom of the side cover 420 and may form a space for receiving the second lever 520. A lower end of the first connection groove 525 of the second lever 520 may be formed to be outwardly bent in order to be coupled to and received in the formed space. Accordingly, the first connection groove 525 is caught by the first coupling protrusion 423, and thus the second lever 520 is prevented from being separated from the side cover 420. As shown in FIGS. 7b and 7c, a transverse width of the front end directional arm part 523b of the second lever 520 is greater than a transverse width of the second connection groove 526. That is, the second coupling protrusion 424 of the side cover 420 is elastically coupled to the second lever 520 by transversely pressurizing the second connection groove 526 of the second lever 520, and prevents the second lever 520 from being separated from the side cover 420.

Embodiments of the adaptor part according to the present invention will be described.

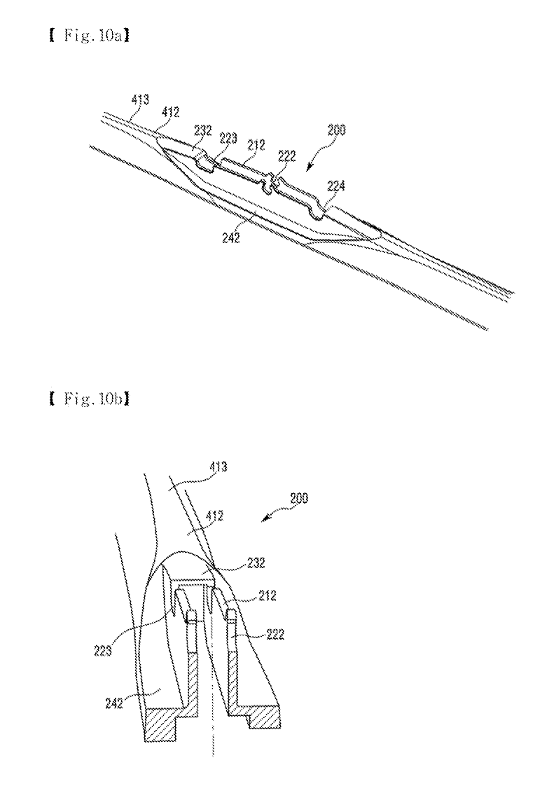

FIG. 10a is a perspective view of an adaptor part of the wiper blade according to a first embodiment of the present invention.

Referring to FIG. 10a, the adaptor part 200 according to the present invention includes a central part 212 and a pair of front ends 232. The central part 212 may include a fitting recess 222 which is formed in the center of the central part 212 and is connected to the connector (not shown), and a first receiver 223 and a second receiver 224 which meet a lower portion of the connector (not shown).

The adaptor part 200 is formed in a concave part 242 located approximately in the center of the connection holder part 412 of the cover 400. It is preferable that the concave part 242 is formed in a trapezoidal shape of which the width becomes narrower toward the wiper strip 600 in such a manner that the connection holder part finned section 415a, i.e., a portion of the central finned section 415 of the wiper blade is connected to the lower portion of the connection holder part 412. However, the shape of the concave part 242 is not limited to the trapezoidal shape. The concave part 242 may be formed in a U-shape. A bottom surface of the adaptor part 200 is formed to fit the shape of the concave part 242.

As shown in FIGS. 5 and 8b, the connection holder part 412 includes the finned section 415a extending toward both front ends of the wiper blade 10 from the lower portion thereof. The connection holder part finned section 415a, together with the first lever cover finned section 415b formed in the first lever cover 413, forms the central finned section 415 of the central cover 410. When the vehicle is driven, the connection holder part finned section 415a distributes a pressurizing force to the entire wiper blade 10 by causing the pressure of traveling wind applied to the wiper blade to flow right and left.

Accordingly, the adaptor part 200 is formed in the connection holder part 412 including the finned part 415a. Further, since the adaptor part 200 is integrally formed with the cover 400, the adaptor part 200 is made of the same resin material as that of the cover 400. Therefore, for the purpose of obtaining rigidity, the lower portion of the adaptor part 200 is formed in a closed type instead of an open type.

FIG. 10b is a transverse cross-sectional view of the adaptor part 200 shown in FIG. 10a.

As shown in FIG. 10b, the central parts 212 are formed to face each other with an axis corresponding to a transverse center of the wiper blade and vertically protrude. The central parts 212 may be formed of a pair of plate-shaped members. The first receiver 223 and the second receiver 224 which meet the lower portion of the connector (not shown) are formed in both ends of the central part 212. The fitting recess 222 for a coupling to the connector (not shown) is formed in the center of the central part 212.

As shown in FIG. 10b, the central parts 212 are formed to be symmetrical with respect to the transverse center of the wiper blade 10. That is, the fitting recesses 222, the first receiver 223, and the second receiver 224 are formed to be symmetrical with respect to the transverse center of the wiper blade 10. The fitting recess 222 is formed to have a circular groove shape in a longitudinal direction center of the wiper blade 10.

The front end 232 is formed in both ends of the adaptor part 200 and contacts with the first receiver 223 and the second receiver 224 of the central part 212 respectively. The front end 232 may be formed to maintain a constant height from the connection holder part 412.

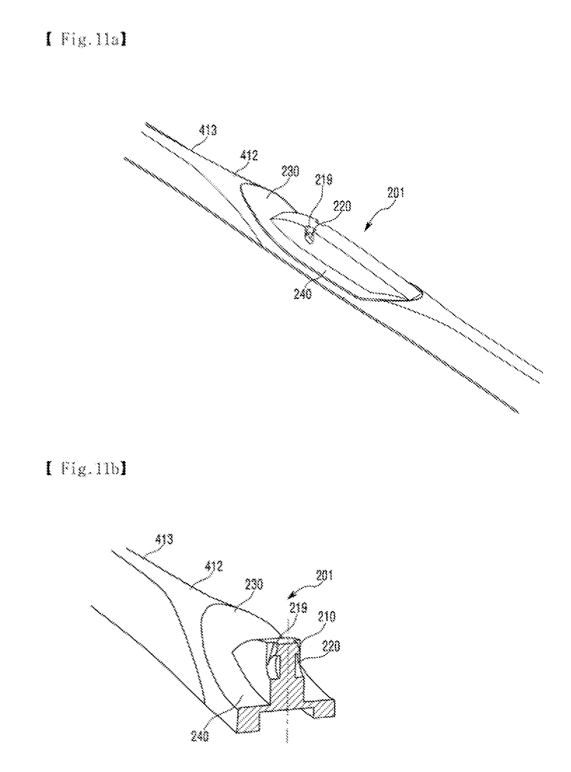

FIG. 11a is a perspective view of an adaptor part of the wiper blade according to a second embodiment of the present invention.

Referring to FIG. 11a, an adaptor part 201 is formed in the center of the cover, and includes the fitting recess 220 connected to the connector (not shown).

The adaptor part 201 is formed in a concave part 240 located approximately in the center of the connection holder part 412 of the cover 400. It is preferable that the concave part 240 is formed in a trapezoidal shape of which the width becomes narrower toward the wiper strip 600 in such a manner that the connection holder part finned section 415a, i.e., a portion of the central finned section 415 of the wiper blade is connected to the lower portion of the connection holder part 412. However, the shape of the concave part 240 is not limited to the trapezoidal shape. The concave part 240 may be formed in a U-shape. In this embodiment, a bottom surface of the adaptor part 201 is not necessarily formed to exactly fit the concave part 240.

As shown in FIGS. 5 and 8b, the connection holder part 412 includes the finned section 415a extending toward both front ends of the wiper blade 10 from the lower portion thereof. The connection holder part finned section 415a, together with the first lever cover finned section 4156b formed in the first lever cover 413, forms the central finned section 415 of the central cover 410. When the vehicle is driven, the connection holder part finned section 415a distributes a pressurizing force to the entire wiper blade 10 by causing the pressure of traveling wind applied to the wiper blade to flow right and left.

Accordingly, the adaptor part 201 is formed in the connection holder part 412 including the finned part 415a. Further, since the adaptor part 201 is integrally formed with the cover 400, the adaptor part 201 is made of the same resin material as that of the cover 400. Therefore, for the purpose of obtaining rigidity, the lower portion of the adaptor part 201 is formed in a closed type instead of an open type.

The adaptor part 201 is integrally formed with the cover 400 and upwardly protrudes. Since the adaptor part 201 is integrally formed with the wiper blade 10, the rigidity of the wiper blade 10 is increased. One end of the adaptor part 201 meets inclined one end 230 of the concave part 240. The other end of the adaptor pan 201 may be connected to a top surface of the cover 400. The other end of the adaptor part 201 may have a level difference with respect to the cover 400.

As another embodiment, both ends of the adaptor part 201 may be formed to meet inclined surfaces formed in both ends of the concave part 240.

FIG. 11b is a transverse cross-sectional view of the adaptor part 201 of the wiper blade 10 according to the second embodiment of the present invention.

As shown in FIG. 11b, the fitting recess 220 is formed to be symmetrical with respect to the transverse center of the wiper blade 10. The fitting recess 220 is formed to have a circular groove shape in the vicinity of a longitudinal direction center of the wiper blade 10. A guide recess 219 is formed in the adaptor part 201 such that the connector (not shown) is coupled to the fitting recess 220. The guide recess 219 may be inclined such that a transverse width is increased toward the fitting recess 220 from the upper portion of the adaptor part 201. This intends to allow the connector (not shown) to be easily coupled to the fitting recess 220 and not to be easily separated.

Both ends of the concave part 240 are downwardly inclined toward the center from the connection holder part 412 and the inclination may be a straight line or a curve. A cover part of the connector (not shown) may be provided at one of both ends 230. The cover part of the connector (not shown) is guided along the inclination of the one end 230 of the concave part 240 and is able to move forward and backward.

According to the shape of the connector (not shown), both front ends of the adaptor part 201 may be connected to the top surface of the cover 400.

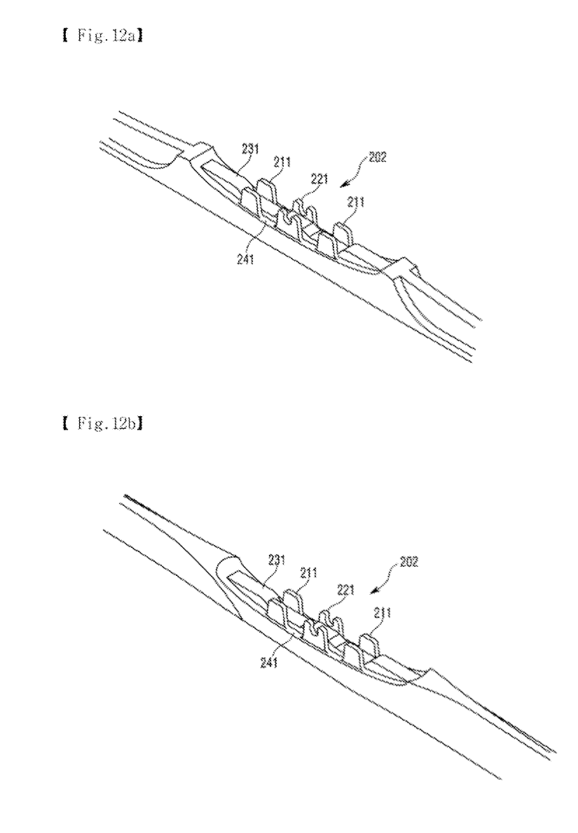

FIGS. 12a and 12b are perspective views of an adaptor part of the wiper blade according to a third embodiment of the present invention.

Referring to FIG. 12a, an adaptor part 202 is formed in a concave part 241 located approximately in the center of the connection holder part 412 of the cover 400. It is preferable that the concave part 241 is formed in a trapezoidal shape of which the width becomes narrower toward the wiper strip 600 in such a manner that the connection holder part finned section 415a, i.e., a portion of the central finned section 415 of the wiper blade is connected to the lower portion of the connection holder part 412. However, the shape of the concave part 241 is not limited to the trapezoidal shape. The concave part 241 may be formed in a U-shape. In this embodiment, a bottom surface of the adaptor part 201 is not necessarily formed to exactly fit the concave part 240. A bottom surface of the adaptor part 202 is formed to fit the shape of the concave part 241.

Since the adaptor part 202 is integrally formed with the cover 400, the adaptor part 202 is made of the same resin material as that of the cover 400. Therefore, for the purpose of obtaining rigidity, the lower portion of the adaptor part 202 is formed in a closed type instead of an open type.

Referring to FIG. 12a, an upper portion of the adaptor part 202 may be formed to include two pairs of connection protrusions 211 and a pair of fitting recesses 221, which mutually face with an axis corresponding to the transverse centerline L1 of the wiper strip 600 and vertically protrude in a longitudinal direction thereof at a predetermined interval. The adaptor part 202 includes a pair of connection protrusions 211, the fitting recess 221 and a front end 231. The connection protrusion 211 is received in the bottom of the connector (not shown) and causes the connector 300 (not shown) to be mounted in the adaptor part 202. The fitting recess 221 is coupled to the connector 300 (not shown) and is hinged by the wiper arm 20. The front ends 231 are formed symmetrically with respect to both front ends of the connection holder part and uniformly from the connection holder part 412.

Referring to FIG. 12b, the adaptor part 202 may be formed in the cover 400 including the finned section. That is, the adaptor part 202 may be formed in the central cover 410 including the finned section.

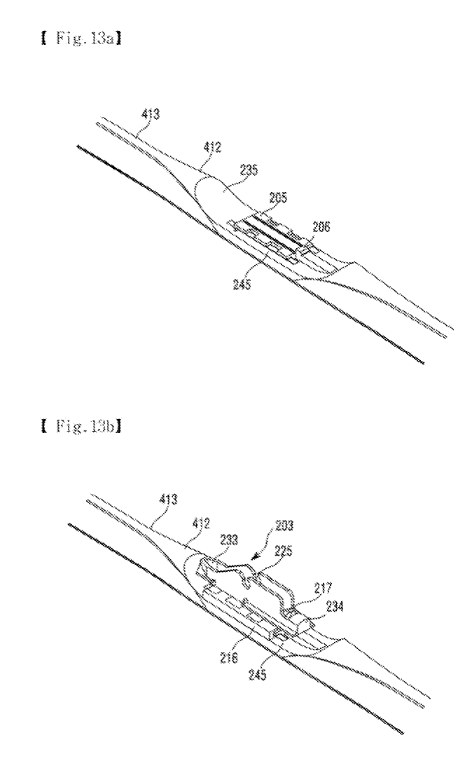

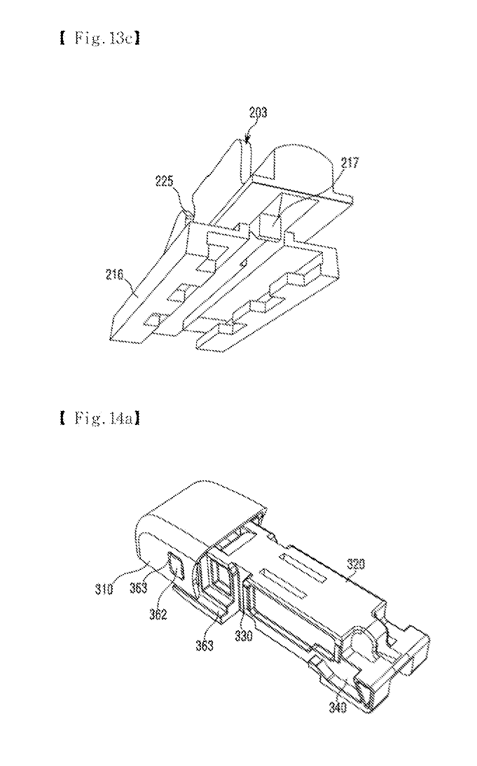

FIG. 13a is a perspective view of the wiper blade according to an embodiment in which an adaptor part 203 is attachable to and removable from the wiper blade 10.

FIG. 13b is a perspective view of the wiper blade with the adaptor part 203 attached thereto.

FIG. 13c is a bottom perspective view of the attachable/removable adaptor part 203.

The adaptor part 203 shown in FIGS. 13b and 13c include a fitting recess 225, a first receiving groove 233 and a second receiving groove 234, which are the same as those of the adaptor part 200 described in the first embodiment.

The wiper blade 10 includes a seating part 205 on the top surface of the connection holder part in order to be connected to the attachable/removable adaptor part 203. The seating part 205 is formed in a concave part 245 located approximately in the center of the connection holder part 412 of the cover 400. The adaptor part 203 is formed in a concave part 245 located approximately in the center of the connection holder part 412 of the cover 400. It is preferable that the concave part 245 is formed in a trapezoidal shape of which the width becomes narrower toward the wiper strip 600 in such a manner that the connection holder part finned section 415a, i.e., a portion of the central finned section 415 of the wiper blade is connected to the lower portion of the connection holder part 412. However, the shape of the concave part 245 is not limited to the trapezoidal shape. The concave part 245 may be formed in a U-shape.

As shown in FIGS. 5 and 8b, the connection holder part 412 includes the finned section 415a extending toward both front ends of the wiper blade 10 from the lower portion thereof. The connection holder part finned section 415a, together with the first lever cover finned section 415b formed in the first lever cover 413, forms the central finned section 415 of the central cover 410. When the vehicle is driven, the connection holder part finned section 415a distributes a pressurizing force to the entire wiper blade 10 by causing the pressure of traveling wind applied to the wiper blade to flow right and left. Therefore, the adaptor part 203 is formed in the connection holder part 412 including the finned section 415a.

A seating part catching protrusion 206 for a coupling to or a removal from the adaptor part 203 is provided on one side of the adaptor seating part 205. The seating part 205 has an unevenness structure for the coupling to the adaptor part 203, and in response to this, the adaptor part 203 also has the unevenness structure, so that the seating part 205 and the adaptor part 203 are engaged with each other. That is, the adaptor part 203 further includes an unevenness part 216 and an adaptor part latch 217 for a coupling to the seating part 205 of the wiper blade 10. When the adaptor part is pushed forward after the unevenness part 216 of the adaptor part 203 is engaged with the unevenness structure of the seating part 205, forward and backward movements of the adaptor part latch 217 are restrained by the seating part catching protrusion 206.

In attaching and removing the adaptor part 203, the adaptor part 203 is unlocked from the seating part catching protrusion 206 by lifting the adaptor part latch 217, so that the adaptor part 203 is able to move backward. Then, the adaptor part 203 can be separated upward.

The unevenness part 216 of the attachable/removable adaptor part 203 has a shape allowing the adaptor part 203 to be coupled to the seating part 205 of the wiper blade. The shape of the top surface of the adaptor part 203 may be changed according to the coupling to the connector (not shown). The shape of the couplable connector (not shown) is changed according to the wiper arm 20, and the shape of the couplable adaptor is changed according to the connector (not shown). Accordingly, the attachable/removable adaptor part 203 can select the adaptor part and the connector for one wiper blade 10 in accordance with the shape of the wiper arm 20.

As described above, since the adaptor part 203 is attachable and removable, the adaptor part 203 can be coupled to various wiper arms 20 of one wiper blade 10.

Next, an embodiment of the connector will be described. Prior to the description of the embodiment of the connector, a shape of the wiper arm which can be connected to the connector according to the present invention will be described.

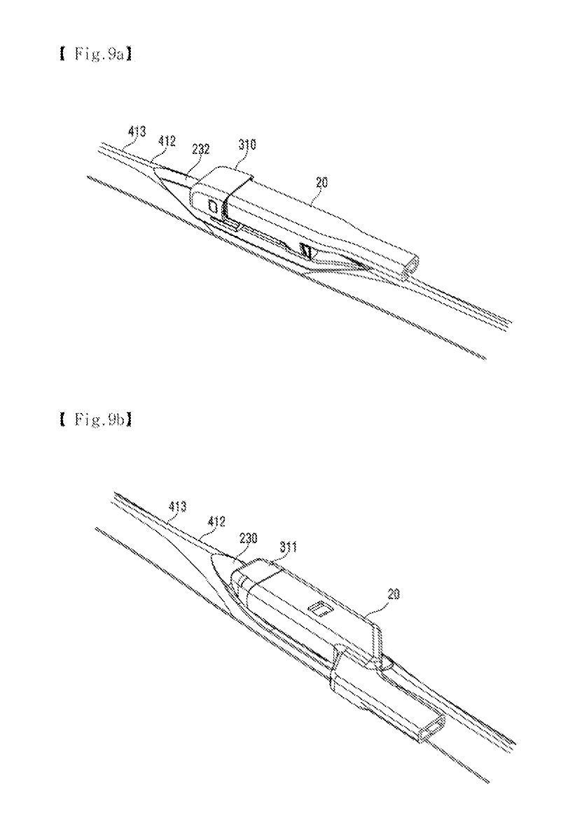

FIGS. 9a and 9b are views showing connection states of the wiper arm applied to an embodiment of the present invention.

FIG. 9a is a partial perspective view showing a state where the connector according to the present is coupled to the wiper arm including a tap which is formed in the wiper arm and contacts with the top surface and both sides of the connector and extends toward the cover part. FIG. 9b is a partial perspective view showing a state where the connector according to the present is coupled to the wiper arm including a cap which contacts with the top surface and both sides of the connector.

As shown in FIGS. 9a and 9b, the wiper blade 10 for a vehicle is attachably/removably provided to the wiper arm 20 which is connected to a driving source of a vehicle body, transfers rotation power and has a predetermined length. The connector 300 is mounted to the wiper blade shown in FIGS. 2a and 2b, and then the wiper shown in FIGS. 9a and 9b may be coupled to the connector. The adaptor part 200 is installed within the connection holder part 412, so that the adaptor part 200 may be assembled with various types of driving arms together with the connector to be described below.

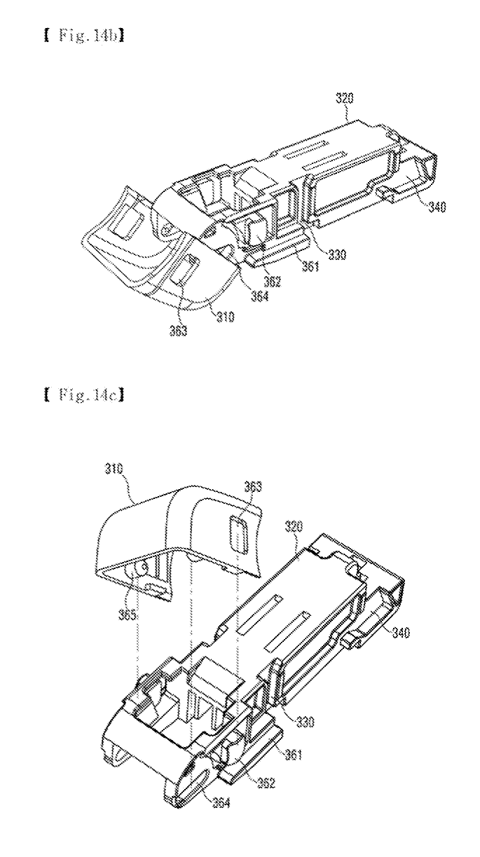

FIGS. 14a, 14b, 14c, and 14d are views showing the connector 300 mounted to the adaptor part 200. Referring to FIGS. 10a and 14d, the lower portion of the connector 300) is opened to be coupled to the adaptor part 200. Referring to FIGS. 14a, 14b, 14c, and 14d, the connector 300 includes a body 320 and a cover part 310.

Referring to FIGS. 14a to 144, the body 320 includes a fitting part 350 for a coupling to the adaptor part 200. The body 320 may include a first coupling part 330 and a second coupling part 340. The first coupling part 330 and the second coupling part 340 may be selectively connected to a wiper arm (ta) including a tap which contacts with the top surface and both sides of the connector 300 shown in FIG. 9a and extends toward the cover part 310 or may be connected to a wiper arm (ca) including a cap which contacts with the top surface and both sides of the connector 300 shown in FIG. 9b.

Also, as shown in FIG. 144, the bottom surface of the body 320 includes a pair of slit grooves 354 in order to allow the central part 212 of the adaptor part 200 to be received in the slit groove 354. Referring to FIGS. 10a and 14d, when the central part 212 of the adaptor part 200 is received in the slit groove 354, a pair of the slit grooves 354 meets the central part 212 at four sides. Therefore, the slit groove 354 and the central part 212 slide at the four sides. Since sliding area is increased and a lower space of the connector 300 is reduced, a gap caused by the wiping is reduced and the wiping is stably performed.

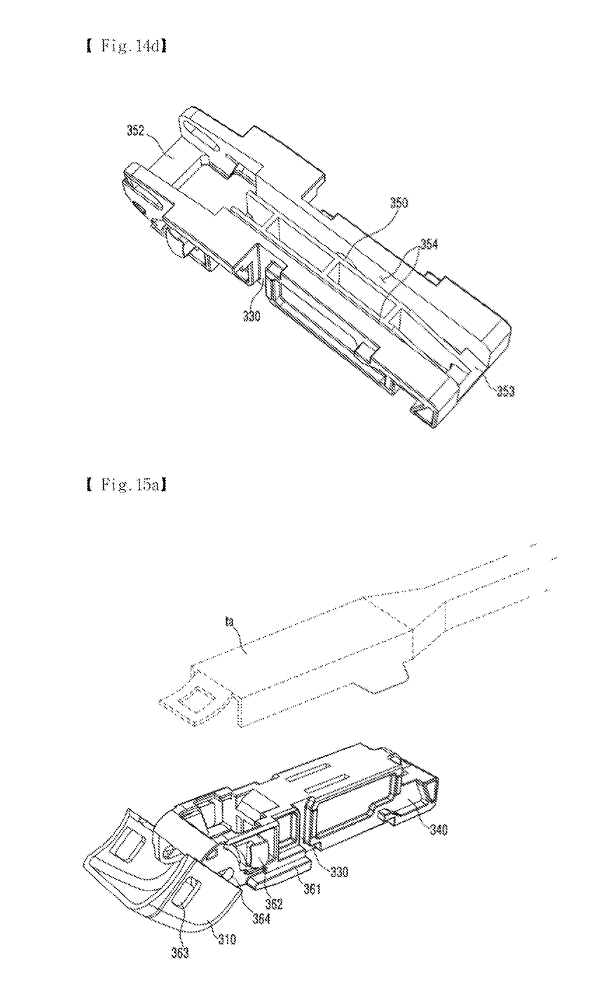

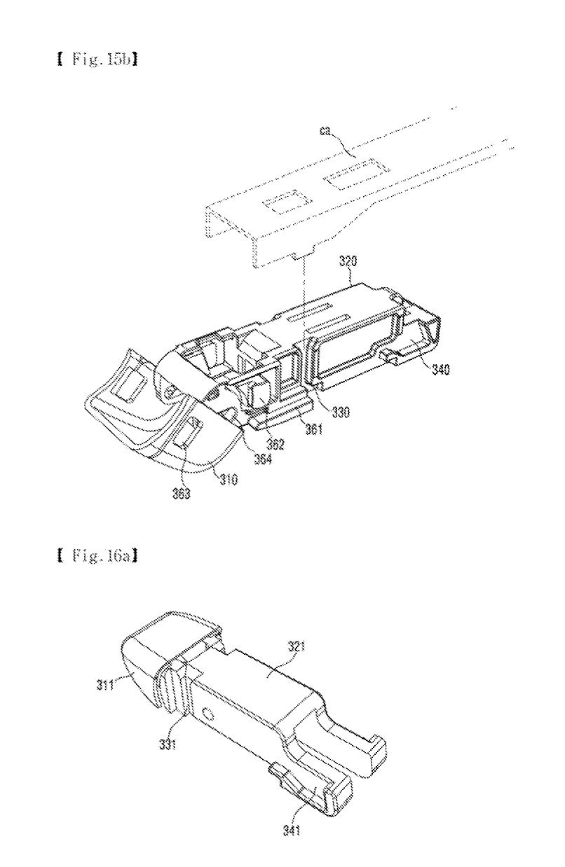

FIGS. 15a and 15b show assembly type of the wiper blade coupled to various types of wiper arms.

As shown in FIG. 14c, a pair of coupling protrusions 365 and a catching recess 363 for a coupling to the body 320 are formed within the cover part 310. A pair of coupling protrusions 365 is inserted and fixed to a coupling recess 364 formed in the body 320 and guides the forward and backward movements of the cover part 310. In order to attach or remove the wiper arm to or from the connector 300, the cover part 310 requires a horizontal straight linear movement guided by the coupling recess 364. Therefore, the cover part 310 is not opened by the rotation moment of the wiper arm when the wiping is performed, so that the wiper arm can be prevented from being separated from the wiper blade.

Also, since the cover part 310 is connected to the body 320, a possibility that the cover part 310 is lost is reduced.

The coupling protrusion 365 functions as a rotation axis when the cover part 310 rotates.

The body 320 may include a guide part 361 for guiding a front and back of the cover part 310, the coupling recess 364 to which the coupling protrusion 365 of the cover part 310 is coupled, and an elastic catching piece 362 which is elastically coupled to the catching recess 363.

Referring to FIGS. 10a and 14a to 14d, the fitting part 350 which is received in the fitting recess 222 of the adaptor part 200 and mounts the connector 300 to the adaptor part 200 is included within the lower portion of the connector 300. The adaptor part 200 is formed of a resin material, and thus the fitting recess 222 elastically receives fitting part 350 of the connector 300, thereby preventing the connector 300 from being separated from the adaptor part 200.

Referring to FIGS. 14a to 14d, the first coupling part 330 includes a slot recess and a sliding part in order to be coupled to the wiper arm (ca) including a cap which contacts with the top surface and both sides of the connector 300. The slot recess is formed in the first coupling part 330 guiding from the upper portion to the lower portion of the connector 300. The sliding part is formed in the lower portion of the connector 300 such that a catching protrusion of the wiper arm guided along the slot recess slides backward and supported in the sliding part.

The second coupling part 340 is formed to support the catching protrusion of the wiper arm (ta) including a tap which contacts with the top surface and both sides of the connector 300 and extends toward the cover part 310. The cover part 310 is formed to surround the upper portion of the body 320. The cover part 310 is able to prevent forward, backward, and upward movement of the wiper arm by covering on a portion of the front end of the wiper arm. A first lower portion 352 formed in the lower portion of the body 320 may be engaged with the first receiver 223 of the adaptor part 200. A second lower portion 353 formed in the lower rear portion of the body 320 may be engaged with the second receiver 224 of the adaptor part 200. The cover part 310 is formed to surround some upper portion of the body 320.

Referring to FIGS. 10a, 10b, 10c and 14a to 144, the coupling of the connector 300 and the adaptor part 200 will be described.

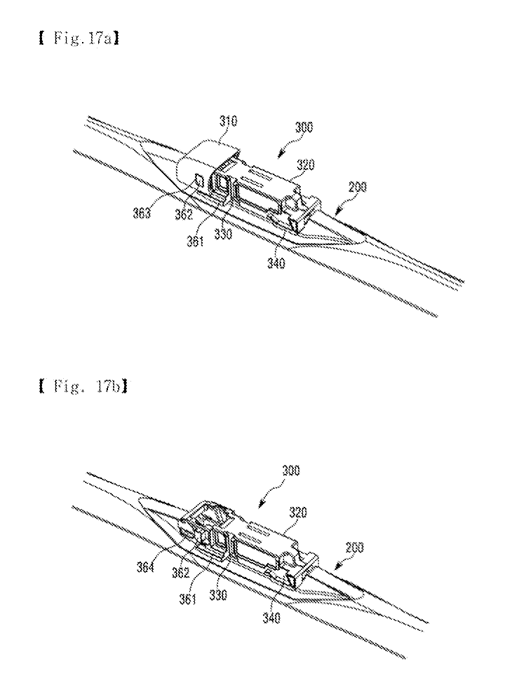

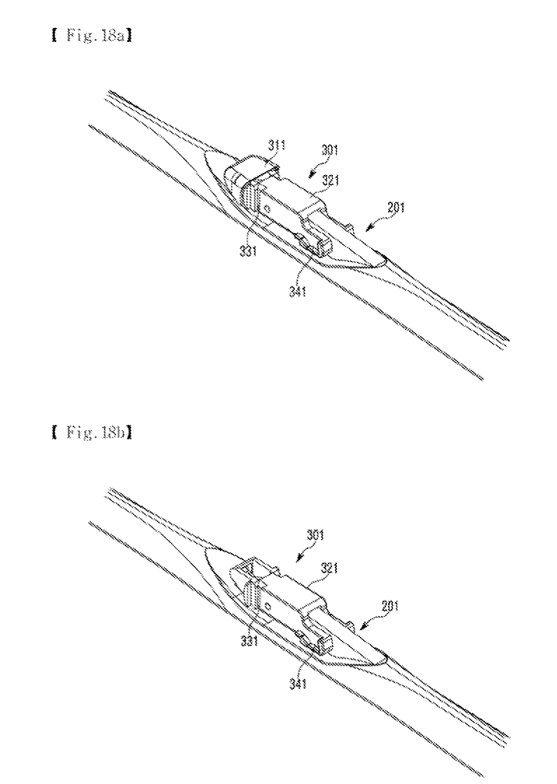

FIG. 17a shows that the connector 300 is mounted to the adaptor part 200. FIG. 17b shows the adaptor part 200 of FIG. 17a without the cover part 310.

The connector 300 is coupled downward from the top of the adaptor part 200. The connector 300 includes the fitting part 350 received in the fitting recess 222 of the adaptor central part 212. The fitting recess 222 of the adaptor central part 212 elastically pressurizes the fitting part 350 transversely to prevent the connector 300 from being separated from the adaptor part 200.

As shown in FIGS. 14a to 14d, the guide part 361 enabling the cover part 310 of the connector to slide forward and backward may be formed in the lower portion of the connector 300. The guide part 361 may be formed inclined toward the front end of the connector 300.

In a case where the wiper arm is coupled to the connector 300, when the wiper arm is coupled to and supported by the first coupling part 330 or the second coupling part 340 which has been formed in the side of the connector 300, the cover part 310 of the connector 300 slides toward the rear of the connector 300 along the guide part 361, and the elastic catching piece 362 formed in the side of the body 320 of the connector 300 is coupled to the catching recess 363 formed in the side of the cover part 310 and protrudes outwardly from the catching recess 363. As a result, the wiper arm is restricted from moving forward, backward and upward. A pair of the elastic catching pieces 362 and a pair of the catching recesses 363 may be formed on both sides of the connector 300 or the elastic catching piece 362 and the catching recess 363 may be formed only on one side of the connector 300.

A process of separating the wiper arm 20 from the wiper blade assembly will be described.

As shown in FIGS. 14a to 14d and 17b, when the right and left of the elastic catching piece 362 protruding from the catching recess 363 of the cover part 310 are pressed and the elastic catching piece 362 is released from the catching recess 363, the cover part 310 of the connector 300 slides in a farther direction from the center of the connector 300 on the basis of the longitudinal direction of the wiper blade 10. After the cover part 310 slides to the end of the guide part 361, the cover part 310 is rotatable at an angle of 90 degree downward with respect to the proceeding direction of the connector 300. When the cover part 310 of the connector 300 rotates about the coupling protrusion 365 formed in the cover part 310, the wiper arm can be separated from the first coupling part 330 or the second coupling part 340.

As such, when the cover part 310 restricts or releases the wiper arm, the cover part 310 moves along the front straight line, and then rotates. Accordingly, in this case, it is possible to obtain more excellent space utilization than that when the cover part 310 moves forward and backward. That is, since the opening becomes larger, it is easy to mount the wiper arm to the connector 300. Therefore, the connector 300 according to the embodiment of the present invention requires less space than a space required by the connector in a case where the cover part 310 moves along the straight line, so that the length of the adaptor part 200 to which the connector is coupled may be shortened. Also, the length of the concave part 242 in which the adaptor part 200 is formed may be shortened. Accordingly, the concave part 242 occupies a smaller space of the wiper blade 10, so that it is easy to obtain the rigidity of the wiper blade 10. Further, the guide part 361 prevents the cover part 310 from being opened by the rotation moment of the wiper arm when the wiping is performed, thereby preventing the wiper arm from being separated from the wiper blade.

Meanwhile, while the embodiment of the present invention describes that the fitting part 350 of the connector 300 is received in and coupled to the fitting recess 222 of the adaptor part 200, there is no limit to this. It is obvious that the fitting recess formed in the connector 300 may be coupled to the fitting part formed in the adaptor part 200.

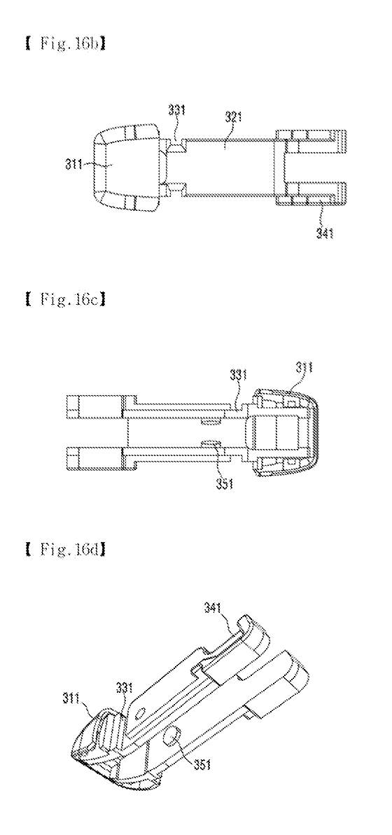

FIGS. 16a to 16d show a connector 301 mounted to the adaptor part 201. Referring to FIGS. 16a to 16d, the lower portion of the connector 301 is opened to be coupled to the adaptor part 201. Referring to FIGS. 16a to 16d, the connector 301 includes a body 321 and a cover part 311.

The body 321 may include a first coupling part 331 and a second coupling part 341. The wiper arm (ta) including a tap which contacts with the top surface and both sides of the connector 301 and extends toward the cover part 311 is connected to the second coupling part 341. The wiper arm (ca) including a cap which contacts with the top surface and both sides of the connector 301 may be selectively connected to the first coupling part 331.

A fitting part 351 is received in the fitting recess 220 of the adaptor part 201 shown in FIG. 11a.

The cover part 311 may move along the inclination of the front end 230 of the concave part 240.

Referring to FIGS. 11a and 16d, the lower portion of the connector 301 is opened to receive the adaptor part 201. The inside of the lower portion of the connector 301 includes the fitting part 351 which is received in the fitting recess 220 of the adaptor part 201 and mounts the connector 301 to the adaptor part 201.

As described in the first embodiment, similarly to FIGS. 15a and 15b, the wiper arm (ca) including a cap which contacts with the top surface and both sides of the connector 301 may be connected to the first coupling part 331. The wiper arm (ta) including a tap which contacts with the top surface and both sides of the connector 301 and extends toward the cover part 311 may be connected to the second coupling part 341.

The front end of the cover part 311 may be formed to become higher such that the cover part 311 is engaged with the one end 230 of the concave part 240. The cover part 311 is formed to surround some upper portion of the body 321. The cover part 311 is able to prevent forward, backward, and upward movement of the wiper arm by covering on a portion of the front end of the wiper arm.

FIG. 18a shows that the connector 301 is mounted to the adaptor part 201. FIG. 18b shows the adaptor part 201 of FIG. 18a without the cover part 311.

Referring to FIGS. 11a, 11b and 11c and FIGS. 14a to 14d, the coupling of the connector 301 and the adaptor part 201 will be described.

As shown in FIGS. 11a and 11b and FIGS. 16a to 16d, the connector 301 is coupled downward from the top of the adaptor part 201. The fitting part 351 of the connector 301 is guided by the guide recess 219 and is inserted and fixed to the fitting recess 220. The guide recess 219 may be inclined to have a transverse width which becomes larger toward the fitting recess 220 from the upper portion of the adaptor part 201. As a result, the connector 301 and the fitting part 351 are easily coupled to each other and are not easily separated from each other.

The connector 301 includes the fitting part 351 received in the fitting recess 220 of the adaptor part 201. The fitting part 351 inserted and fixed to the fitting recess 220 of the adaptor part 201 elastically pressurizes the adaptor part 201 transversely to prevent the connector 301 from being separated.

Hereafter, the following is a description of how the wiper arm is coupled to the connector 301 in a state where the connector 301 is mounted on the adaptor part 201.

The connector 301 is mounted on the adaptor part 201, and the wiper arm is coupled to the connector 301.

The body 321 may include the first coupling part 331 to which the wiper arm (ca) including a cap contacting with the top surface and both sides of the connector 301 may be selectively connected.

The wiper arm (ca) has the catching protrusion for the coupling to the connector 301. The wiper arm (ca) is vertically induced along the first coupling part 331 of the connector 301 from the top to the bottom of the first coupling part 331 and slides toward the rear of the connector 301 from the lower end of the connector 301, and then is rear supported. The forward movement of the wiper arm (ca) is controlled by the cover part 311 of the connector 301.

Also, the body 321 may include the second coupling part 341 to which the wiper arm (ta) including a cap which contacts with the top surface and both sides of the connector 301 and extends toward the cover part 311 is connected.

The connector 301 includes the second coupling part 341 for a coupling to the wiper arm (ta). The coupling protrusion of the wiper arm is fixed and inserted into the second coupling part 340 of the connector 301 and then is rear supported. The cover part 311 covers on the front end of the wiper arm 20. The rotation and the forward movement of the wiper arm (ta) are controlled by the cover part 311.

The lower portion of the cover part 311 of the connector 301 is formed to contact with the one end 230 of the concave part 240.

In a case where the wiper arm 20 is coupled to the connector 301, when the wiper arm 20 is coupled to and supported by the first coupling part 331 or the second coupling part 341 which has been formed in the side of the connector 300, the cover part 311 restricts the front end of the wiper arm by moving forward and backward along the one end 230 of the concave part 240 shown in FIG. 11a. As a result, the wiper arm is prevented from being forwardly and upwardly separated.

A method of separating the wiper arm 20 from the wiper blade assembly will be described. As shown in FIGS. 11a, 11b and 18a to 18b, the cover part 311 is able to move forward along the one end 230 of the concave part 240. When the cover part 311 of the connector 301 moves along the one end 230 of the concave part 240, the wiper arm can be separated from the first coupling part 331 or the second coupling part 341.

While it is described in the embodiment of the present invention that the fitting part 351 of the connector 301 is received in and coupled to the fitting recess 220 of the adaptor part 201, there is no limit to this. It is obvious that the fitting recess formed in the connector 301 is coupled to the fitting part formed in the adaptor part 201.

The features, structures and effects and the like described in the embodiments are included in at least one embodiment of the present invention and are not necessarily limited to one embodiment. Furthermore, the features, structures, effects and the like provided in each embodiment can be combined or modified in other embodiments by those skilled in the art to which the embodiments belong. Therefore, contents related to the combination and modification should be construed to be included in the scope of the present invention.

Although the present invention has been described based on the preferred embodiment thereof, the embodiment is only illustrative and does not limit the present invention. It can be understood that those skilled in the art can achieve various modifications and applications that are not illustrated herein, without departing from the essential characteristics of the present invention. That is, each component described in the embodiments in detail may be modified and then implemented in various ways. Furthermore, it should be understood that the differences associated with the modifications and applications are included in the scope of the present invention, which is defined in the accompanying claims.

What is claimed is:

1. A wiper connector for a vehicle, which connects a wiper arm to a wiper blade, the wiper connector comprising:
a body which is connected to the wiper arm by receiving a catching protrusion of the wiper arm through use of at least one coupling part formed on both sides thereof; and
a cover part restricting forward and backward or upward and downward movement of the wiper arm coupled to the body, wherein the body comprises a fitting part which is provided on the bottom surface thereof and is fitted and coupled to a fitting recess formed in a central portion of the wiper blade.

2. The wiper connector for a vehicle of claim 1, wherein at least one catching recess is formed in at least one side of the cover part, and wherein the body comprises at least one elastic catching piece protruding outwardly in order to be coupled to the at least one catching recess.

3. The wiper connector for a vehicle of claim 2, wherein the body further comprises a guide part for guiding a linear movement of the cover part.

4. The wiper connector for a vehicle of claim 2, wherein the body comprises a coupling recess formed in both sides thereof, and wherein a pair of coupling protrusions formed within the cover part is coupled to the coupling recess, guides the forward and backward movements of the cover part and functions as a rotation axis when the cover part rotates.

5. The wiper connector for a vehicle of claim 1, wherein the body comprises a pair of slit grooves on a bottom surface thereof.

6. The wiper connector for a vehicle of claim 1, wherein the wiper connector is selectively connected either to a first wiper arm comprising a tap which contacts with the top surface and both sides of the wiper connector and extends toward the cover part, or to a second wiper arm comprising a cap which contacts with the top surface and both sides of the wiper connector.
